(19) United States
(12) Patent Application Publication
(10) Pub. No.: US 2026/0243647 A1
(43) Pub. Date: Aug. 20, 2026

(54) PARTICLE DIFFERENTIAL MOBILITY ANALYZER AND PARTICLE SEPARATING AND COUNTING APPARATUS USING THE SAME

(71) Applicant: INNOVATIVE NANOTECH INCORPORATED, Hsinchu City (TW)

(72) Inventors: Cheng-Feng Lee, Hsinchu City (TW); Chih-Hao Ting, Hsinchu City (TW); Hsin-Chia Ho, Hsinchu City (TW); Huang-Di Lin, Hsinchu City (TW); Yong-Sin Yang, Hsinchu City (TW); Rou-Yi Chen, Hsinchu City (TW)

(73) Assignee: INNOVATIVE NANOTECH INCORPORATED, Hsinchu City (TW)

(21) Appl. No.: 19/439,081

(22) Filed: Jan. 2, 2026

(30) Foreign Application Priority Data
Feb. 14, 2025 (TW) 114105642
Sep. 9, 2025 (TW) 114209576

(51) Int. Cl. G01N 15/02; G01N 11/08; G01N 11/00; G01N 15/00

(52) U.S. Cl. CPC G01N 15/0266; G01N 11/08; G01N 2011/002; G01N 2015/0003; G01N 2015/0061

(57) ABSTRACT

A particle differential mobility analyzer includes a mass flow control device, a temperature sensor, a pressure sensor, and a particle separation chamber. Clean dry gas outputted at a mass flow rate by the mass flow control device is adjusted to a first volume flow rate according to a temperature and a pressure by a controller. The particle separation chamber includes a clean gas receiving end receiving the clean dry gas input at the first volume flow rate, an aerogel receiving end receiving an aerogel input at a second volume flow rate, a mixed gas outputting end extracting a mixed aerogel at a third volume flow rate, and a residual gas discharging end discharging a remaining mixed aerogel at a fourth volume flow rate. The third volume flow rate is equal to the second volume flow rate, and the fourth volume flow rate is equal to the first volume flow rate.

### CROSS-REFERENCE TO RELATED APPLICATIONS

This non-provisional application claims priority under 35 U.S.C. § 119(a) to Patent Application No. 114105642 filed in Taiwan, R.O.C. on Feb. 14, 2025 and Patent Application No. 114209576 filed in Taiwan, R.O.C. on Sep. 9, 2025, the entire contents of which are hereby incorporated by reference.

### BACKGROUND

### Technical Field

The present invention relates to the field of detection, and in particular, to a particle differential mobility analyzer and a particle separating and counting apparatus using the same.

### Related Art

As a semiconductor process evolves, a critical dimension is miniaturized to a nanometer level, leading to an increasingly stringent specification for particles in an overall process environment, equipment, a raw material, and a process solution. Generally, monitoring of the particles in the process solution is achieved by atomizing the particles into an aerogel, and using a particle separator to separate the particles according to particle sizes through a constant electric field and a flow rate.

A type of a conventional particle separator is internal circulation, but the process solution contains a corrosive solution such as hydrochloric acid, sulfuric acid, and hydrogen peroxide. After long-term internal circulation, a concentration may accumulate, which may cause corrosion of an internal component. This may lead to destruction of the entire equipment, and both cost of the equipment and cost of downtime are quite high. Therefore, a manner of inputting a clean gas from the outside is developed, to avoid accumulation of a corrosive aerogel and even further rapidly remove the aerogel, thereby avoiding corrosion of an internal component.

However, the most common problem with the particle separator using externally supplied clean air is instability of air intake volume. Currently, a float-type flow meter is often used to calculate a volume flow rate of air intake. However, since the float-type flow meter is mostly analog, precise control is difficult, and this may lead to misjudgment of particle separation, possibly causing a huge error in judgment of a micro-process.

### SUMMARY

To resolve the foregoing problems, a particle differential mobility analyzer is provided herein. The particle differential mobility analyzer includes a mass flow control device, a temperature sensor, a pressure sensor, and a particle separation chamber. The mass flow control device is connected to a clean dry gas storage tank and electrically connected to a controller to output a clean dry gas at a mass flow rate. The temperature sensor and the pressure sensor are connected to the mass flow control device and electrically connected to the controller, to sense temperature and pressure of the clean dry gas, generate temperature information and pressure information, and send the temperature information and the pressure information to the controller, and the controller adjusts the mass flow rate to a first volume flow rate based on the temperature information and the pressure information.

The particle separation chamber is applied to an electric field, and includes a clean gas receiving end, an aerogel receiving end, a mixed gas outputting end, and a residual gas discharging end. The clean gas receiving end is connected to the mass flow control device, to receive the clean dry gas input at the first volume flow rate. The aerogel receiving end receives an aerogel input at a second volume flow rate. The mixed gas outputting end extracts, at a third volume flow rate, a mixed aerogel obtained by mixing the aerogel and the clean dry gas, where the third volume flow rate is equal to the second volume flow rate, and the third volume flow rate is less than the first volume flow rate. The residual gas discharging end discharges a remaining mixed aerogel at a fourth volume flow rate, where the fourth volume flow rate is equal to the first volume flow rate.

In some embodiments, the mixed gas outputting end is connected to a counting apparatus, the counting apparatus is further electrically connected to the controller and outputs flow rate information to the controller, and when the counting apparatus adjusts the third volume

flow rate, the controller controls and changes the first volume flow rate according to the flow rate information, the temperature information, and the pressure information, where a sum of the first volume flow rate and the second volume flow rate is equal to a sum of the third volume flow rate and the fourth volume flow rate.

In some embodiments, the aerogel receiving end is connected to a manifold, where the manifold includes a connection end, an outputting end, and a bypass end. The outputting end is connected to the aerogel receiving end, and a gas intake flow rate input through the connection end is equal to a sum of the second volume flow rate output through the outputting end and a bypass gas outputting flow rate output through the bypass end.

In some embodiments, the first volume flow rate and the fourth volume flow rate range from 2 L/min to 20 L/min, the second volume flow rate and the third volume flow rate range from 0.2 L/min to 4 L/min, and a sum of the first volume flow rate and the second volume flow rate ranges from 2.2 L/min to 25 L/min.

More specifically, in some embodiments, the first volume flow rate and the fourth volume flow rate range from 12 L/min to 18 L/min, the second volume flow rate and the third volume flow rate range from 0.8 L/min to 2.5 L/min, and the sum of the first volume flow rate and the second volume flow rate ranges from 12 L/min to 18 L/min.

In some embodiments, the residual gas discharging end further includes a fourth orifice plate and is connected to a fourth vacuum pump, and the fourth vacuum pump and the fourth orifice plate control the remaining mixed aerogel to be extracted at the fourth volume flow rate.

More specifically, in some embodiments, the fourth vacuum pump is electrically connected to the controller, and when the fourth orifice plate is replaced, the controller controls and changes the first volume flow rate according to the fourth volume flow rate changed by the fourth vacuum pump.

In some embodiments, a second mass flow control device, a second temperature sensor, and a second pressure sensor are further disposed at the residual gas discharging end, the second mass flow control device, the second temperature sensor, and the second pressure sensor are electrically connected to the controller, and the second mass flow control device controls the remaining mixed aerogel to be discharged at a second mass flow rate. The second temperature sensor and the second pressure sensor sense a temperature and a pressure of the mixed aerogel, generate second temperature information and second pressure information, and send the temperature information and the pressure information to the controller, and the controller adjusts the second mass flow rate to a fourth volume flow rate based on the second temperature information and the second pressure information.

In some embodiments, when the controller controls the second mass flow control device to change the fourth volume flow rate, the controller simultaneously controls the mass flow rate controller to change the first volume flow rate.

In some embodiments, the particle separation chamber includes a plurality of particle collection channels, and a plurality of particles in the aerogel are separated according to different particle sizes based on the electric field and the first volume flow rate, and are guided into the particle collection channels.

A particle separating and counting apparatus is further provided herein, which includes a particle differential mobility analyzer and a counting apparatus. The particle differential mobility analyzer includes a mass flow controller, a temperature sensor, a pressure sensor, and a particle separation chamber. The mass flow control device is connected to a clean dry gas storage tank and electrically connected to a controller to output a clean dry gas at a mass flow rate. The temperature sensor and the pressure sensor are connected to the mass flow controller and electrically connected to the controller, to sense a temperature and a pressure of the clean dry gas, generate temperature information and pressure information, and send the temperature information and the pressure information to the controller, and the controller adjusts the mass flow rate to a first volume flow rate based on the temperature information and the pressure information.

The particle separation chamber is applied to an electric field, and includes a clean gas receiving end, an aerogel receiving end, a mixed gas outputting end, and a residual gas discharging end. The clean gas receiving end is connected to the mass flow controller, to receive the clean dry gas input at the first volume flow rate. The aerogel receiving end receives an aerogel input at a second volume flow rate, where a ratio of the second volume flow rate to the first volume flow rate ranges from 1:2 to 1:10. The mixed gas outputting end outputs a mixed aerogel obtained by mixing the aerogel and the clean dry gas at a third volume flow rate, where the third volume flow rate is equal to the second volume flow rate, and the third volume flow rate is less than the first volume flow rate. The residual gas discharging end discharges a remaining mixed aerogel at a fourth volume flow rate, where the fourth volume flow rate is equal to the first volume flow rate. The counting apparatus extracts the mixed aerogel at the third volume flow rate.

In some embodiments, the counting apparatus includes a third orifice plate and a third vacuum pump, and the third vacuum pump and the third orifice plate control the mixed aerogel to be extracted at the third volume flow rate.

More specifically, in some embodiments, the counting apparatus further includes a mixed aerogel inputting end, a laser chamber, a bypass tube, a fifth orifice plate, and a fifth vacuum pump. The mixed aerogel inputting end is connected to the mixed gas outputting end. The laser chamber is connected to the mixed aerogel inputting end, the fifth orifice plate and the fifth vacuum pump are connected to the laser chamber and the third vacuum pump, and extract the mixed aerogel into the laser chamber at a fifth volume flow rate, and the mixed aerogel passing through the laser chamber is extracted by the fifth vacuum pump and transferred to the third vacuum pump. The bypass tube is connected to the third orifice plate and the third vacuum pump, and the mixed aerogel that does not enter the laser chamber is extracted by the third vacuum pump through the bypass tube.

Further, in some embodiments, a hole size of the fifth orifice plate is less than a hole size of the third orifice plate.

Further, in some embodiments, a third volume flow rate ranges from 0.8 L/min to 4.5 L/min, and the fifth volume flow rate ranges from 0.1 L/min to 0.5 L/min.

In some embodiments, the counting apparatus includes a variable orifice plate and the third vacuum pump, and the third vacuum pump and the variable orifice plate control the mixed aerogel to be extracted at the third volume flow rate, where the third vacuum pump is electrically connected to the controller, when a hole size of the variable orifice plate changes, the controller controls and changes the second volume flow rate according to the third volume flow rate changed by the third vacuum pump.

In some embodiments, a ratio of the second volume flow rate to the first volume flow rate ranges from 1:3.5 to 1:7.5.

More specifically, in some embodiments, the ratio of the second volume flow rate to the first volume flow rate ranges from 1:4 to 1:6.5.

In some embodiments, the third volume flow rate ranges from 0.8 L/min to 4.5 L/min, and the first volume flow rate ranges from 1.5 L/min to 45 L/min.

As described in the foregoing embodiments, the mass flow control device, the pressure sensor, and the temperature sensor effectively control air intake and air discharging volumes of the particle separation chamber to be consistent, can perform program control, can ensure that no misjudgment occurs in particle separation in a non-internal circulation system, and can be applied to a more precise process.

### BRIEF DESCRIPTION OF THE DRAWINGS

FIG. 1 is a block diagram of a first embodiment of a particle differential mobility analyzer.

FIG. 2 is a block diagram of a second embodiment of the particle differential mobility analyzer.

FIG. 3 is a block diagram of an embodiment of a particle separating and counting apparatus.

FIG. 4 is a block diagram of an embodiment of a counting apparatus.

### DETAILED DESCRIPTION

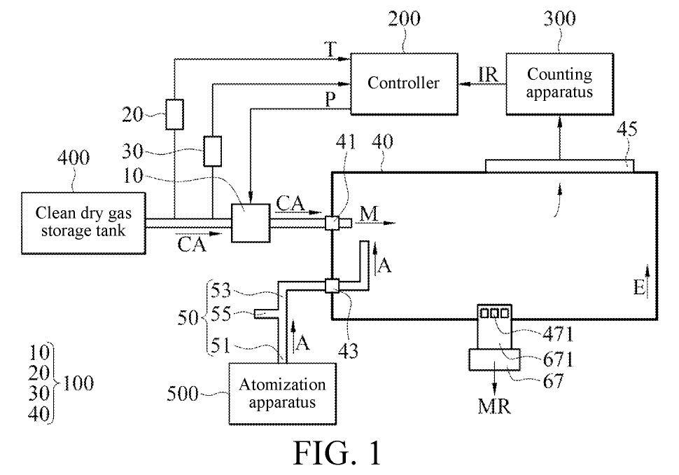

FIG. 1 is a block diagram of a first embodiment of a particle differential mobility analyzer. As shown in FIG. 1, a particle differential mobility analyzer 100 includes a mass flow control device 10, a temperature sensor 20, a pressure sensor 30, and a particle separation chamber 40. The mass flow control device 10 is connected to a clean dry gas storage tank 400 and electrically connected to a controller 200 to output a clean dry gas CA at a mass flow rate. The temperature sensor 20 and the pressure sensor 30 are connected to the mass flow control device 10 and electrically connected to the controller 200, to sense a temperature and a pressure of the clean dry gas, generate temperature information T and pressure information P, and send the temperature information and the pressure information to the controller 200, and the controller 200 adjusts the mass flow rate to a first volume flow rate based on the temperature information T and the pressure information P.

The particle separation chamber 40 is applied to an electric field E, and includes a clean gas receiving end 41, an aerogel receiving end 43, a mixed gas outputting end 45, and a residual gas discharging end 47. The clean gas receiving end 41 can be connected to the mass flow control device 10 through a pipeline, to receive the clean dry gas CA input at the first volume flow rate. The aerogel receiving end 43 receives an aerogel A input at a second volume flow rate. The mixed gas outputting end 45 extracts, at a third volume flow rate, a mixed aerogel M obtained by mixing the aerogel A and the clean dry gas CA and outputs the mixed aerogel M to a counting apparatus 300, where the third volume flow rate is equal to the second volume flow rate, and the third volume flow rate is less than the first volume flow rate. The residual gas discharging end 47 discharges a remaining mixed aerogel MR at a fourth volume flow rate, where the fourth volume flow rate is equal to the first volume flow rate.

More specifically, the particle separation chamber 40 includes a plurality of particle collection channels, and a plurality of particles in the aerogel A are separated according to particle sizes based on the electric field E and the first volume flow rate, and are guided into the particle collection channels.

Herein, through a manifold 50, the particle separation chamber 40 maintains an air intake volume input from the aerogel receiving end 43. The mixed gas outputting end 45 is connected to the counting apparatus 300 at a rear end to perform extraction at a constant volume using a vacuum pump (not shown in the figure), and the residual gas discharging end 47 is connected to a fourth vacuum pump 67 to perform extraction at a constant volume. Therefore, the second volume flow rate, the third volume flow rate, and the fourth volume flow rate are approximately constant values. Details are described below. Research indicates that an unbalanced volume flow rate is mainly because the first volume flow rate is not equal to the fourth volume flow rate due to inability of the clean gas receiving end 41 to accurately control the first volume flow rate. Herein, a programmable mass flow control device 10 is used to replace a float-type flow meter, and through the temperature sensor 20 and the pressure sensor 30, an input volume flow rate is determined by using a gas equation PV=nRT, thereby maintaining overall flow rate balance, avoiding instability of the air intake volume, and avoiding misjudgment of particle sizes in particle separation.

More specifically, in some embodiments, the first volume flow rate and the fourth volume flow rate range from 2 L/min to 20 L/min, and preferably, from 12 L/min to 18 L/min, for example, 15 L/min. The second volume flow rate and the third volume flow rate range from 0.2 L/min to 4 L/min, preferably, from 0.8 L/min to 2.5 L/min, for example, 1.5 L/min. In addition, a sum of the first volume flow rate and the second volume flow rate ranges from 2.2 L/min to 25 L/min, preferably, from 12 L/min to 18 L/min.

More specifically, in some embodiments, the aerogel receiving end 43 is connected to the manifold 50, and the manifold 50 includes a connection end 51, an outputting end 53, and a bypass end 55. The outputting end 53 is connected to the aerogel receiving end 43. The aerogel A is input to the particle separation chamber 40 through the aerogel receiving end 43 at a constant volume flow rate, that is, the second volume flow rate. The connection end 51 is connected to an atomization apparatus 500 from a front section. The bypass end 55 serves as a bypass, and discharges the aerogel A exceeding the second volume flow rate. Herein, a gas intake flow rate input through the atomization apparatus 500 is equal to a sum of the second volume flow rate output through the outputting end 53 and a bypass gas outputting flow rate output through the bypass end 55.

In addition, a fourth orifice plate 671 is further disposed at the residual gas discharging end 47, and is connected to the fourth vacuum pump 67. The fourth orifice plate 671 limits a volume of discharged mixed aerogel, and the vacuum pump 67 and the fourth orifice plate 671 control the remaining mixed aerogel MR to be extracted at the fourth volume flow rate. Further, the fourth vacuum pump 67 may alternatively be electrically connected to the controller 200. When the fourth orifice plate 671 is replaced, that is, a hole size and a volume flow rate for gas extraction are adjusted, the controller 200 controls and changes the first volume flow rate according to the fourth volume flow rate changed by the fourth vacuum pump 67.

In some embodiments, the counting apparatus 300 is also electrically connected to the controller 200 and outputs flow rate information IR to the controller 200, and when the counting apparatus 300 adjusts the third volume flow rate, the controller 200 controls and changes the first volume flow rate according to the flow rate information IR, the temperature information T, and the pressure information P, maintaining the sum of the first volume flow rate and the second volume flow rate equal to a sum of the third volume flow rate and the fourth volume flow rate.

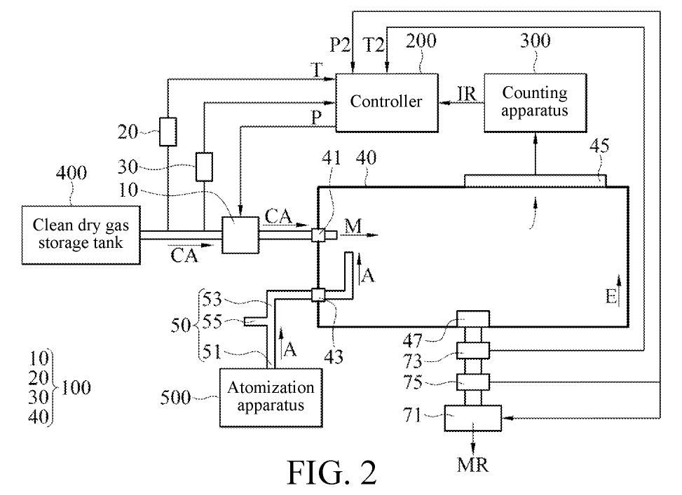

FIG. 2 is a block diagram of a second embodiment of the particle differential mobility analyzer. As shown in FIG. 2, and referring to FIG. 1, a difference from the first embodiment is that the residual gas discharging end 47 is not configured by combining the fourth orifice plate 671 and the fourth vacuum pump 67, but configured by combining a second mass flow control device 71, a second temperature sensor 73, and a second pressure sensor 75. The second mass flow control device 71, the second temperature sensor 73, and the second pressure sensor 75 are electrically connected to the controller 200, where the second mass flow control device 71 controls the remaining mixed aerogel MR to be discharged at a second mass flow rate. The second temperature sensor 73 and the second pressure sensor 75 sense a temperature and a pressure of the mixed aerogel MR, generate second temperature information T2 and second pressure information P2, and send the temperature information T2 and the pressure information R2 to the controller 200, and the controller 200 adjusts the second mass flow rate to a fourth volume flow rate based on the second temperature information T2 and the second pressure information P2. At the same time, the controller 200 also adjusts the first volume flow rate corresponding to the fourth volume flow rate, thereby achieving a dynamic balance between flow rates.

Further, when the controller 200 controls the second mass flow control device 71 to change the fourth volume flow rate, the controller 200 simultaneously controls the mass flow control device 10 to change the first volume flow rate.

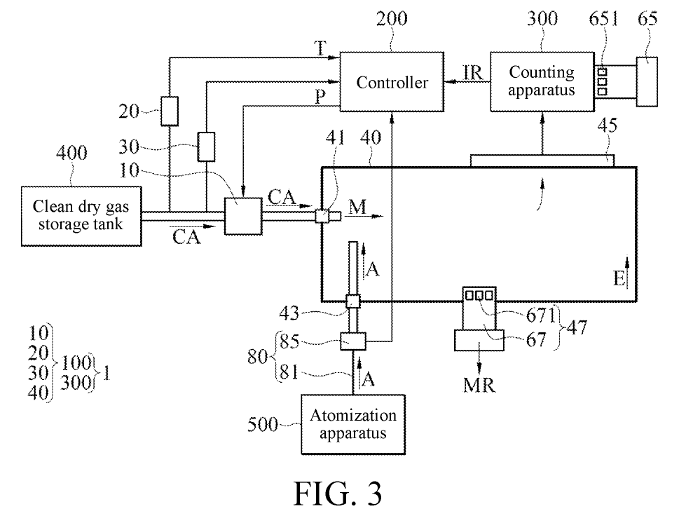

FIG. 3 is a block diagram of an embodiment of a particle separating and counting apparatus. As shown in FIG. 3, a particle separating and counting apparatus 1 includes a particle differential mobility analyzer 100 and a counting apparatus 300. In other words, the particle separating and counting apparatus 1 is a combination of the particle differential mobility analyzer 100 and the counting apparatus 300. The particle differential mobility analyzer 100 is as described above, and details are not repeated. Only differences, especially in control of a flow rate, are further explained. As described above, a sum of a first volume flow rate and a second volume flow rate is equal to a sum of a third volume flow rate and a fourth volume flow rate. The fourth volume flow rate is equal to the first volume flow rate, and the third volume flow rate is equal to the second volume flow rate.

An aerogel receiving end 43 can input an aerogel A into a particle separation chamber 40 at the second volume flow rate through a mass flow rate controller 80, for example, a manifold 81 and/or a gas valve 85. A fourth orifice plate 671 is further disposed at a residual gas discharging end 47, and is connected to a fourth vacuum pump 67, and the fourth orifice plate 671 limits a volume of a discharged mixed aerogel MR, so that the vacuum pump 67 and the fourth orifice plate 671 can control the remaining mixed aerogel MR to be extracted at the fourth volume flow rate. The counting apparatus 300 extracts the mixed aerogel M at the third volume flow rate. Therefore, provided that the first volume flow rate is precisely controlled, balance between air intake volumes is achieved. The programmable mass flow control device 10 is used to replace a float-type flow meter, and through a temperature sensor 20 and a pressure sensor 30, the input first volume flow rate is determined by using a gas equation PV=nRT, thereby maintaining overall flow rate balance, avoiding instability of the air intake volume, and avoiding misjudgment of particle sizes in particle separation. The mass flow rate controller 80 may alternatively be further electrically connected to a controller 200 to precisely control an air intake flow rate of the aerogel A.

Herein, the third volume flow rate is less than the first volume flow rate. More specifically, the third volume flow rate ranges from 0.8 L/min to 4.5 L/min, and the first volume flow rate ranges from 1.5 L/min to 45 L/min. Herein, a ratio of the second volume flow rate to the first volume flow rate ranges from 1:2 to 1:10. Preferably, in some embodiments, the ratio of the second volume flow rate to the first volume flow rate ranges from 1:3.5 to 1:7.5. More preferably, in some embodiments, the ratio of the second volume flow rate to the first volume flow rate ranges from 1:4 to 1:6.5. Through a specific second volume flow rate and a specific first volume flow rate, that is, a proportion of the aerogel A diluted with the clean dry gas CA, sensitivity of the counting apparatus 300 for particle counting is improved, especially for a well-controlled environment of a semiconductor manufacturing company.

Further, in some embodiments, the counting apparatus 300 is also electrically connected to the controller 200 and outputs flow rate information IR to the controller 200, and when the counting apparatus 300 adjusts the third volume flow rate, the controller 200 controls and changes the first volume flow rate according to the flow rate information IR, the temperature information T, and the pressure information P, maintaining the sum of the first volume flow rate and the second volume flow rate equal to a sum of the third volume flow rate and the fourth volume flow rate.

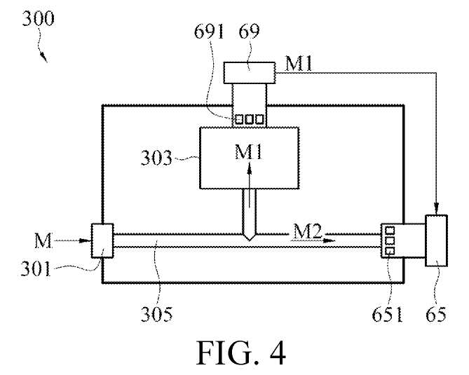

FIG. 4 is a block diagram of an embodiment of a counting apparatus. As shown in FIG. 4, the counting apparatus 300 includes a mixed aerogel inputting end 301, a laser chamber 303, a bypass tube 305, a third orifice plate 651, a third vacuum pump 65, a fifth orifice plate 691, and a fifth vacuum pump 69. The third orifice plate 651 and the third vacuum pump 65 extract the mixed aerogel M from a particle separating apparatus 100 at the third volume flow rate, and input the mixed aerogel M into the counting apparatus 300 through the mixed aerogel inputting end 301. After passing through the mixed aerogel inputting end 301, a part of the aerogel, for example, a first mixed aerogel M1, enters the laser chamber 303 through the bypass tube 305 for optical counting. Herein, the first mixed aerogel M1 is extracted to the laser chamber 303 through the fifth orifice plate 691 and the fifth vacuum pump 69 at a fifth volume flow rate. The first mixed aerogel M1 measured by the laser chamber 303 is extracted by the fifth vacuum pump 69 and then transferred to the third vacuum pump 65 before being discharged. A mixed aerogel that does not enter the laser chamber 303 in the bypass tube 305 and a second mixed aerogel M2 are directly extracted through the third orifice plate 651 and the third vacuum pump 65.

A hole size of the fifth orifice plate 691 is less than a hole size of the third orifice plate 651, and a purpose is only to extract the first mixed aerogel M1 to the laser chamber 303 at a constant volume flow rate. More specifically, in some embodiments, the third volume flow rate ranges from 0.8 L/min to 4.5 L/min, and the fifth volume flow rate ranges from 0.1 L/min to 0.5 L/min.

Further, the third orifice plate 651 may be a variable orifice plate, through which the hole size is changed to adjust the third volume flow rate. Herein, the third vacuum pump 65 is electrically connected to the controller 200. When the variable orifice plate (namely, the third orifice plate 651) changes the hole size, the controller 200 controls and changes the second volume flow rate according to the third volume flow rate changed by the third vacuum pump 65. Similarly, the fourth vacuum pump 67 may alternatively be electrically connected to the controller 200. When the fourth orifice plate 671 or a hole size fourth orifice plate 671 is changed, the controller 200 controls and changes the first volume flow rate according to the fourth volume flow rate changed by the fourth vacuum pump 67, thereby maintaining overall gas flow rate balance.

In conclusion, the mass flow control device 10, the temperature sensor 20, and the pressure sensor 30 effectively control air intake and air discharging volumes of the particle separation chamber 40 to be consistent, can perform precise program control, can ensure that no misjudgment occurs in particle separation in a non-internal circulation system, and can be applied to a more precise process.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A particle differential mobility analyzer, comprising:
a mass flow control device connected to a clean dry gas storage tank and electrically connected to a controller, to output a clean dry gas at a mass flow rate;
a temperature sensor and a pressure sensor connected to the mass flow control device and electrically connected to the controller, to sense a temperature and a pressure of the clean dry gas, generate temperature information and pressure information, and send the temperature information and the pressure information to the controller, wherein the controller adjusts the mass flow rate to a first volume flow rate based on the temperature information and the pressure information; and
a particle separation chamber applied to an electric field, and comprising:
a clean gas receiving end connected to the mass flow control device to receive the clean dry gas input at the first volume flow rate;
an aerogel receiving end receiving an aerogel input at a second volume flow rate;
a mixed gas outputting end extracting a mixed aerogel obtained by mixing the aerogel and the clean dry gas at a third volume flow rate, wherein the third volume flow rate is equal to the second volume flow rate, and the third volume flow rate is less than the first volume flow rate; and
a residual gas discharging end discharging a remaining mixed aerogel at a fourth volume flow rate, wherein the fourth volume flow rate is equal to the first volume flow rate.

2. The particle differential mobility analyzer according to claim 1, wherein the mixed gas outputting end is connected to a counting apparatus, the counting apparatus is further electrically connected to the controller and outputs a flow rate information to the controller, and when the counting apparatus adjusts the third volume flow rate, the controller controls and changes the first volume flow rate according to the flow rate information, the temperature information, and the pressure information, wherein a sum of the first volume flow rate and the second volume flow rate is equal to a sum of the third volume flow rate and the fourth volume flow rate.

3. The particle differential mobility analyzer according to claim 1, wherein the aerogel receiving end is connected to a manifold, the manifold comprises a connection end, an outputting end, and a bypass end, the outputting end is connected to the aerogel receiving end, and a gas intake flow rate input through the connection end is equal to a sum of the second volume flow rate output through the outputting end and a bypass gas outputting flow rate output through the bypass end.

4. The particle differential mobility analyzer according to claim 1, wherein the first volume flow rate and the fourth volume flow rate range from 2 L/min to 20 L/min, the second volume flow rate and the third volume flow rate range from 0.2 L/min to 4 L/min, and a sum of the first volume flow rate and the second volume flow rate ranges from 2.2 L/min to 25 L/min.

5. The particle differential mobility analyzer according to claim 4, wherein the first volume flow rate and the fourth volume flow rate range from 12 L/min to 18 L/min, the second volume flow rate and the third volume flow rate range from 0.8 L/min to 2.5 L/min, and the sum of the first volume flow rate and the second volume flow rate ranges from 12 L/min to 18 L/min.

6. The particle differential mobility analyzer according to claim 1, wherein a fourth orifice plate is further disposed at the residual gas discharging end and is connected to a fourth vacuum pump, and the fourth vacuum pump and the fourth orifice plate control the remaining mixed aerogel to be extracted at the fourth volume flow rate.

7. The particle differential mobility analyzer according to claim 6, wherein the fourth vacuum pump is electrically connected to the controller, and when the fourth orifice plate is replaced, the controller controls and changes the first volume flow rate according to the fourth volume flow rate changed by the fourth vacuum pump.

8. The particle differential mobility analyzer according to claim 1, wherein a second mass flow control device, a second temperature sensor, and a second pressure sensor are further disposed at the residual gas discharging end, the second mass flow control device, the second temperature sensor, and the second pressure sensor are electrically connected to the controller, the second mass flow control device controls the remaining mixed aerogel to be discharged at a second mass flow rate, the second temperature sensor and the second pressure sensor sense a temperature and a pressure of the mixed aerogel, generate second temperature information and second pressure information, and send the second temperature information and the second pressure information to the controller, and the controller adjusts the second mass flow rate to the fourth volume flow rate according to the second temperature information and the second pressure information.

9. The particle differential mobility analyzer according to claim 8, wherein when the controller controls the second mass flow control device to change the fourth volume flow rate, the controller simultaneously controls the mass flow control device to change the first volume flow rate.

10. The particle differential mobility analyzer according to claim 1, wherein the particle separation chamber comprises a plurality of particle collection channels, and a plurality of particles in the aerogel are separated according to particle sizes based on the electric field and the first volume flow rate, and are guided into the particle collection channels.

11. A particle separating and counting apparatus, comprising:
a particle differential mobility analyzer, comprising:
a mass flow controller connected to a clean dry gas storage tank and electrically connected to a controller, to output a clean dry gas at a mass flow rate;
a temperature sensor and a pressure sensor connected to the mass flow controller and electrically connected to the controller, to sense a temperature and a pressure of the clean dry gas, generate temperature information and pressure information, and send the temperature information and the pressure information to the controller, wherein the controller adjusts the mass flow rate to a first volume flow rate based on the temperature information and the pressure information; and
a particle separation chamber applied to an electric field, and comprising:
a clean gas receiving end connected to the mass flow controller, to receive the clean dry gas input at the first volume flow rate;
an aerogel receiving end receiving aerogel input at a second volume flow rate, wherein a ratio of the second volume flow rate to the first volume flow rate ranges from 1:2 to 1:10;
a mixed gas outputting end outputting a mixed aerogel obtained by mixing the aerogel and the clean dry gas at a third volume flow rate, wherein the third volume flow rate is equal to the second volume flow rate, and the third volume flow rate is less than the first volume flow rate; and
a residual gas discharging end, discharging a remaining mixed aerogel at a fourth volume flow rate, wherein the fourth volume flow rate is equal to the first volume flow rate; and
a counting apparatus extracting the mixed aerogel at the third volume flow rate.

12. The particle separating and counting apparatus according to claim 11, wherein the counting apparatus comprises a third orifice plate and a third vacuum pump, and the third vacuum pump and the third orifice plate control the mixed aerogel to be extracted at the third volume flow rate.

13. The particle separating and counting apparatus according to claim 12, wherein the counting apparatus further comprises a mixed aerogel inputting end, a laser chamber, a bypass tube, a fifth orifice plate, and a fifth vacuum pump, wherein the mixed aerogel inputting end is connected to the mixed gas outputting end, the laser chamber is connected to the mixed aerogel inputting end, the fifth orifice plate and the fifth vacuum pump are connected to the laser chamber and the third vacuum pump and extract the mixed aerogel into the laser chamber at a fifth volume flow rate, the mixed aerogel passing through the laser chamber is extracted by the fifth vacuum pump and transferred to the third vacuum pump, the bypass tube is connected to the third orifice plate and the third vacuum pump, and the mixed aerogel that does not enter the laser chamber is extracted by the third vacuum pump through the bypass tube.

14. The particle separating and counting apparatus according to claim 13, wherein a hole size of the fifth orifice plate is less than a hole size of the third orifice plate.

15. The particle separating and counting apparatus according to claim 13, wherein a third volume flow rate ranges from 0.8 L/min to 4.5 L/min, and the fifth volume flow rate ranges from 0.1 L/min to 0.5 L/min.

16. The particle separating and counting apparatus according to claim 11, wherein the counting apparatus comprises a variable orifice plate and a third vacuum pump, and the third vacuum pump and the variable orifice plate control the mixed aerogel to be extracted at the third volume flow rate, wherein the third vacuum pump is electrically connected to the controller, when a hole size of the variable orifice plate changes, the controller controls and changes the second volume flow rate according to the third volume flow rate changed by the third vacuum pump.

17. The particle separating and counting apparatus according to claim 11, wherein the ratio of the second volume flow rate to the first volume flow rate ranges from 1:3.5 to 1:7.5.

18. The particle separating and counting apparatus according to claim 17, wherein the ratio of the second volume flow rate to the first volume flow rate ranges from 1:4 to 1:6.5.

19. The particle separating and counting apparatus according to claim 11, wherein the third volume flow rate ranges from 0.8 L/min to 4.5 L/min, and the first volume flow rate ranges from 1.5 L/min to 45 L/min.
